(19) United States
(12) Patent Application Publication
(10) Pub. No.: US 2025/0307423 A1
(43) Pub. Date: Oct. 2, 2025

(54) METHOD AND APPARATUS FOR EVALUATING ROBUSTNESS OF SERVICE FORECASTING MODEL AND COMPUTING DEVICE

(71) Applicant: Alipay (Hangzhou) Information Technology Co., Ltd., Hangzhou (CN)

(72) Inventors: Shiwen CUI, Hangzhou (CN); Zhifeng LI, Hangzhou (CN); Changhua MENG, Hangzhou (CN); Weiqiang WANG, Hangzhou (CN); Jiaqi ZHANG, Hangzhou (CN)

(21) Appl. No.: 18/861,087

(22) PCT Filed: Apr. 7, 2023
(86) PCT No.: PCT/CN2023/087007

§ 371 Date: Oct. 28, 2024

(30) Foreign Application Priority Data
Apr. 29, 2022 (CN) 202210468467.3

(51) Int. Cl. G06F 21/57

(52) U.S. Cl. CPC G06F 21/577

(57) ABSTRACT

Embodiments of this specification provide a method and an apparatus for evaluating robustness of a service forecasting model, and a computing device. The method includes: obtaining a forecasting result of the service forecasting model for a service label of the first service object; calculating first quantiles respectively corresponding to the plurality of service objects based on first forecasting value of each service object and a first set including each first forecasting value; calculating second quantiles respectively corresponding to the plurality of service objects based on second forecasting value of each service object and the first set; determining respective forecasting errors of the plurality of service objects based on the first quantiles and the second quantiles that respectively correspond to the plurality of service objects; and determining a robustness score of the service forecasting model against an adversarial attack based on the respective forecasting errors of the plurality of service objects.

This application claims priority to Chinese Patent Application No. 202210468467.3, filed with the China National Intellectual Property Administration on Apr. 29, 2022, and entitled “METHOD AND APPARATUS FOR EVALUATING ROBUSTNESS OF SERVICE FORECASTING MODEL, AND COMPUTING DEVICE”, which is incorporated herein by reference in its entirety.

### TECHNICAL FIELD

One or more embodiments of this specification relate to the field of machine learning, and in particular, to a method and an apparatus for evaluating robustness of a service forecasting model, and a computing device.

### BACKGROUND

With development of artificial intelligence technologies, an artificial intelligence model obtained based on the artificial intelligence technology has gained increasingly extensive attention, and is widely applied to various service scenarios, for example, image processing, text processing, or voice signal processing. Here, an artificial intelligence model applied to a service scenario can be referred to as a service forecasting model.

In addition, the artificial intelligence technology also has great impact on a research in the conventional computer security field. In addition to using the artificial intelligence technology to construct various malicious detection and attack recognition systems, an attacker may use the artificial intelligence technology to achieve a more accurate attack. Therefore, it is urgent to ensure that the service forecasting model is not easily affected by the attacker to change a determining result.

Based on a security requirement of the service forecasting model, to prevent the model from having a recognition bug and being broken through, security evaluation needs to be performed on the service forecasting model. Here, a core indicator of security evaluation is robustness of the service forecasting model.

However, currently, robustness evaluation of the service forecasting model is mainly implemented based on a sample label. However, in an actual scenario, the sample label may lag, and a method for implementing robustness evaluation of a service forecasting model without depending on a sample label is urgently needed.

### SUMMARY

One or more embodiments of this specification describe a method and apparatus for evaluating robustness of the service forecasting model, a computer-readable storage medium, and a computing device, to implement model robustness evaluation based on a quantile difference between forecasting values of a service label for an original sample and an adversarial sample of a service object without depending on a sample label and a threshold. In addition, robustness of service forecasting models in different service scenarios can be evaluated in the same manner, to compare performance of the service forecasting models in different service scenarios.

According to a first aspect, a method for evaluating robustness of a service forecasting model is provided, including:
for any first service object in a plurality of service objects, obtaining a forecasting result of a service forecasting model for a service label of the first service object, where the forecasting result includes a first forecasting value obtained through forecasting based on a first service sample corresponding to the first service object and a second forecasting value obtained through forecasting based on a corresponding second service sample, and the second service sample is a sample obtained by performing adversarial processing on the first service sample;
calculating first quantiles respectively corresponding to the plurality of service objects based on a first forecasting value of each service object and a first set including each first forecasting value;
calculating second quantiles respectively corresponding to the plurality of service objects based on a second forecasting value of each service object and the first set;
determining respective forecasting errors of the service labels of the plurality of service objects based on the first quantiles and the second quantiles that respectively correspond to the plurality of service objects; and
determining a robustness score of the service forecasting model against an adversarial attack based on the respective forecasting errors of the service labels of the plurality of service objects.

In a feasible implementation, the calculating first quantiles respectively corresponding to the plurality of service objects includes: for the any first service object, determining a first quantile corresponding to the first service object based on a quantity of forecasting values less than the first forecasting value of the first service object in the first set and a total quantity of first forecasting values in the first set.

In a feasible implementation, the calculating first quantiles respectively corresponding to the plurality of service objects includes: ranking the plurality of service objects based on values of the first forecasting values, to obtain first ranking numbers respectively corresponding to the plurality of service objects; and for the any first service object, calculating a first quantile corresponding to the first service object based on a first ranking number corresponding to the first service object and a total quantity of first forecasting values in the first set.

In a feasible implementation, the calculating second quantiles respectively corresponding to the plurality of service objects based on a second forecasting value of each service object and the first set includes: for the any first service object, when a target service object exists, and a first forecasting value corresponding to the target service object is the same as the second forecasting value corresponding to the first service object, using a first quantile corresponding to the target service object as a second quantile corresponding to the first service object.

In a feasible implementation, the calculating second quantiles respectively corresponding to the plurality of service objects based on second forecasting values of all the service objects and the first set includes: for the any first service object, determining a first quantile corresponding to the first service object based on a quantity of forecasting values less than the second forecasting value of the first service object in the first set and a total quantity of first forecasting values in the first set.

In a feasible implementation, the calculating second quantiles respectively corresponding to the plurality of service objects based on second forecasting values of all the service objects and the first set includes: for the any first service object, ranking the first forecasting value in the first set and the second forecasting value of the first service object based on the values, to determine a second ranking number of the first service object; and calculating a second quantile corresponding to the first service object based on the second ranking number of the first service object and a total quantity of first forecasting values in the first set.

In a feasible implementation, the determining respective forecasting errors of the service labels of the plurality of service objects based on the first quantiles and the second quantiles that respectively correspond to the plurality of service objects includes:
determining a quantile error of the service label of the first service object based on a first quantile and a second quantile that correspond to the first service object; and scaling the quantile error based on a preset scaling function, and using a scaled quantile difference as a forecasting error of the first service object.

In a feasible implementation, the forecasting error is a difference between a first quantile and a second quantile of a corresponding service object.

In a feasible implementation, the robustness score is determined based on at least an average value, a standard deviation, or a variance of respective forecasting errors of the service labels of the plurality of service objects.

In a feasible implementation, the method further includes: for each of a plurality of alternative objects, obtaining a forecasting result of the service label of the alternative object by using the service forecasting model, where the forecasting result includes a first forecasting value obtained through forecasting based on a first service sample corresponding to the alternative object and a second forecasting value obtained through forecasting based on a corresponding second service sample, and the second service sample is a sample obtained by performing adversarial processing on the first service sample; and determining the plurality of service objects from the plurality of alternative objects based on respective first forecasting values or second forecasting values of the plurality of alternative objects.

In an example, the determining the plurality of service objects from the plurality of alternative objects based on respective first forecasting values of the plurality of alternative objects includes: ranking the plurality of alternative objects based on values of the first forecasting values respectively corresponding to the plurality of alternative objects, and determining respective third ranking numbers of the plurality of alternative objects; and determining the plurality of service objects based on the respective third ranking numbers of the plurality of alternative objects.

For example, the plurality of service objects are a plurality of alternative objects with a first ranking, a last ranking, and a ranking number greater than or equal to a first preset ranking number or less than or equal to a second preset ranking number.

In a feasible implementation, the service label is a classification, and the first forecasting value and the second forecasting value are probability values; or the service label is a parameter, and the first forecasting value and the second forecasting value are parameter values.

In a feasible implementation, the service forecasting model is a facial recognition model, the first service object is a user, the first service sample is an original image of the user, and the second service sample is a perturbed image obtained by adding adversarial noise to the original image.

According to a second aspect, an apparatus for evaluating robustness of a service forecasting model is provided, including:
an obtaining module, configured to: for any first service object in a plurality of service objects, obtain a forecasting result of a service forecasting model for a service label of the first service object, where the forecasting result includes a first forecasting value obtained through forecasting based on a first service sample corresponding to the first service object and a second forecasting value obtained through forecasting based on a corresponding second service sample, and the second service sample is a sample obtained by performing adversarial processing on the first service sample;
a first calculation module, configured to calculate first quantiles respectively corresponding to the plurality of service objects based on first forecasting values of all the service objects and a first set including all the first forecasting values;
a second calculation module, configured to calculate second quantiles respectively corresponding to the plurality of first service objects based on second forecasting values of all the first service objects and the first set;
an error determining module, configured to determine respective forecasting errors of the service labels of the plurality of first service objects based on the first quantiles and the second quantiles that respectively correspond to the plurality of first service objects; and
a score determining module, configured to determine a robustness score of the service forecasting model against an adversarial attack based on the respective forecasting errors of the service labels of the plurality of first service objects.

According to a third aspect, a computer-readable storage medium is provided. The computer-readable storage medium stores a computer program, and when the computer program is executed on a computer, the computer is enabled to perform the method in the first aspect.

According to a fourth aspect, a computing device is provided, including a memory and a processor. The memory stores executable code, and when the processor executes the executable code, the method in the first aspect is implemented.

In the embodiments of this specification, model robustness evaluation is implemented based on a quantile difference between forecasting values of a service label for an original sample and an adversarial sample of a service object without depending on a sample label and a threshold. In addition, robustness of service forecasting models in different service scenarios can be evaluated in the same manner, to compare performance of the service forecasting models in different service scenarios.

### BRIEF DESCRIPTION OF DRAWINGS

To describe the technical solutions in the embodiments of this application more clearly, the following briefly describes the accompanying drawings required for describing the embodiments. Clearly, the accompanying drawings in the following description show merely some embodiments of this application, and a person of ordinary skill in the art may still derive other drawings from these accompanying drawings without creative efforts.

FIG. 1 is a schematic diagram illustrating a solution to calculate an evaluation indicator in an embodiment;

FIG. 2 is a schematic diagram illustrating rankings of forecasting values and service objects in an embodiment;

FIG. 3 is a flowchart illustrating a method for evaluating robustness of a service forecasting model in an embodiment; and

FIG. 4 is a schematic structural diagram illustrating an apparatus for evaluating robustness of a service forecasting model in an embodiment.

### DESCRIPTION OF EMBODIMENTS

The solutions provided in this specification are described below with reference to the accompanying drawings.

In recent years, with accumulation of massive data, development of computing capabilities, and continuous innovation and evolution of machine learning methods and systems, artificial intelligence technologies such as image recognition, speech recognition, and natural language translation are widely deployed and widely applied. In addition, the artificial intelligence technology also has great impact on a research in the conventional computer security field. In addition to using the artificial intelligence technology to construct various malicious detection and attack recognition systems, an attacker may use the artificial intelligence technology to achieve a more accurate attack. Therefore, it is urgent to ensure integrity and confidentiality of a service forecasting model and data, so that the service forecasting model and the data are not easily affected by the attacker to change a forecasting result.

Currently, based on a security requirement of the service forecasting model, to prevent the model from having a recognition bug and being broken through, security evaluation needs to be performed on the service forecasting model, to guide training of the service forecasting model. Here, a core indicator of security evaluation is robustness.

In a solution, the robustness of the service forecasting model is evaluated through an adversarial test. The adversarial test can be understood as testing the robustness of the service forecasting model based on an adversarial sample. Correspondingly, the robustness is used to reflect at least performance of the service forecasting model on the adversarial sample. The adversarial sample is a sample obtained by performing adversarial processing on an original sample (an originally collected sample used to test the service forecasting model). The sample can enable the service forecasting model to perform incorrect forecasting, that is, interfere with forecasting of the service forecasting model. Adversarial processing can be understood as slightly perturbing the original sample under a certain constraint, or can be understood as adding adversarial noise to the original sample. For example, in facial recognition, eyeglasses with a special pattern can break through a facial recognition model. Such a picture is an adversarial sample.

An evaluation indicator used to evaluate the robustness can be usually a model accuracy fluctuation difference or an area under the curve (AUC) fluctuation difference. A curve is usually a receiver operating characteristic (ROC) curve.

The accuracy fluctuation difference indicates to calculate a difference between model accuracy before the adversarial test and model accuracy after the adversarial test. The model accuracy is dividing, by a total quantity of forecasted samples, a quantity of samples that are correctly forecasted by a model.

For example, model accuracy of the service forecasting model for a test set is 0.98, model accuracy for an adversarial test set obtained after adversarial noise is added is 0.95, the model accuracy fluctuation difference is 0.03, and 0.03 can describe the robustness of the model (a smaller difference indicates better robustness). Here, the test set is a set including original samples used to test quality of the service forecasting model, and can also be referred to as an original sample set. The adversarial test set is a set of attack samples corresponding to the original samples in the test set.

In a manner in which the model accuracy fluctuation difference is used, the model accuracy needs to be calculated based on a sample label. In addition, when the service forecasting model is used for binary classification, a threshold needs to be specified. For example, 0.9 is used as a decision boundary, a value greater than 0.9 is 1 (indicating a positive class), and a value less than 0.9 is 0 (indicating a negative class).

The AUC fluctuation difference indicates to calculate a difference between an AUC before the adversarial test and an AUC after the adversarial test.

For example, an AUC of the service forecasting model for a test set is 0.98, an AUC for an adversarial test set obtained after adversarial noise is added is 0.9, the AUC fluctuation difference is 0.08, and 0.08 can describe the robustness of the model (a smaller difference indicates better robustness).

In a manner in which the AUC fluctuation difference is used, an AUC needs to be calculated based on a sample label. In addition, the AUC fluctuation difference can only be used for robustness evaluation of a service forecasting model for binary classification, but cannot be used for robustness evaluation of a service forecasting model for multi-classification, regression, etc. In addition, an actual class (a positive class or a negative class) of a sample and a class (a positive class or a negative class) forecasted by the service forecasting model for the sample are considered for the AUC. Therefore, when the service forecasting model for binary classification forecasts a probability of a class, a threshold needs to be set. For example, 0.9 is used as a decision boundary, a value greater than 0.9 is 1 (indicating a positive class), and a value less than 0.9 is 0 (indicating a negative class).

The evaluation indicator depends on the sample label. The robustness of the service forecasting model cannot be evaluated without a label. In addition, in different service scenarios, a uniform evaluation indicator and a uniform threshold cannot be used for robustness evaluation of the service forecasting model, and consequently, robustness of service forecasting models in different service scenarios cannot be compared. A unified evaluation indicator that can cross scenarios and has credibility is lacked.

In view of the above-mentioned problems, the embodiments of this specification propose to design an evaluation indicator based on a quantile difference between forecasting values of the service label for an original sample and an adversarial sample of a service object. In this way, not only the robustness of the service forecasting model can be better evaluated, but also there is no dependency on a threshold and a label of the original sample of the service object. There is good scalability and comparability. If the robustness of the service forecasting models in different service scenarios is evaluated in the same manner, performance of the service forecasting models in different service scenarios can be compared.

Here, the service forecasting model can be any service forecasting model. In the embodiments of this specification, a model structure of the service forecasting model is not limited. Specifically, the model structure of the service forecasting model can be determined with reference to an actual requirement.

In addition, the service label can be understood as an output object of the service forecasting model. For example, the service forecasting model is a classification model, for example, a model used for vehicle detection and recognition. In this case, the output object can be a vehicle type, and there can be a plurality of vehicle types. Correspondingly, a plurality of service labels can be a car, a passenger car, a bus, a subway, a train, a van, a freight car, etc. A service forecasting model is a regression model, for example, a model used to determine an industrial device abnormality score. In this case, an output object can be an industrial device score. Correspondingly, the service label is the industrial device score.

Further, when there are a plurality of service labels, the service forecasting model outputs forecasting values of all service labels. However, when the evaluation indicator is calculated, it is considered that the plurality of service labels are independent of each other. Therefore, evaluation needs to be independently performed for each service label, to determine the robustness of the service forecasting model for the service label. In this way, a manner of evaluating the robustness of the service forecasting model provided in the embodiments of this specification is not limited by a quantity of service labels, and evaluation can be performed for any quantity of service labels. When robustness evaluation is performed on the service forecasting model, evaluations for all service labels need to be comprehensively considered, to evaluate the robustness of the service forecasting model relatively accurately. For example, for any evaluation indicator, indicator values of the evaluation indicators for all service labels are averaged, to obtain an evaluation value of the evaluation indicator of the service forecasting model. Here, the evaluation indicator can be a number deviation (namely, an average value) of a quantile difference, and a number deviation root (namely, a standard deviation). Certainly, the evaluation indicator in this specification is merely used as an example and does not constitute a specific limitation, and can be specifically designed with reference to an actual situation.

To facilitate understanding of application scenarios in the embodiments of this specification, the following uses an example of the application scenarios.

In a first example scenario, the above-mentioned service scenario and the above-mentioned service object can be respectively a facial recognition scenario and a user. Correspondingly, a service forecasting model can be a model used for facial recognition, to be specific, determine an identity of the user based on facial information. There can be a plurality of service labels. Different service labels represent different users. In this case, the service forecasting model is a multi-classification model. Correspondingly, an original sample of the service object is facial data. Here, the facial data can be a photographed face picture. In addition, an adversarial sample can be a face picture obtained after interference is added to the face picture (namely, adversarial processing). Usually, a difference between these face pictures cannot be seen by a naked eye, but the service forecasting model cannot accurately determine the identity of the user.

In a second example scenario, the above-mentioned service scenario and the above-mentioned service object can be a vehicle recognition scenario and a vehicle. Correspondingly, a service forecasting model can be a model used for vehicle detection and classification. There can be a plurality of service labels. Different service labels represent different vehicle types. In this case, the service forecasting model is a multi-classification model. Correspondingly, an original sample of the service object is a photographed vehicle picture of the vehicle. In addition, an adversarial sample can be a vehicle picture obtained after interference is added to the vehicle picture (namely, adversarial processing). Usually, a difference between these vehicle pictures cannot be seen by a naked eye, but the service forecasting model cannot accurately determine a type of the vehicle.

In a third example scenario, the above-mentioned service scenario and the above-mentioned service object can be respectively a voiceprint recognition scenario and a user. Correspondingly, a service forecasting model can be a model used for voiceprint recognition. There can be a plurality of service labels. Different service labels represent different users. In this case, the service forecasting model is a multi-classification model. Correspondingly, an original sample of the service object is voice data. Here, the voice data can be data obtained by collecting a voice of the user by using a microphone. In addition, an adversarial sample can be voice data after interference is added to the voice data (namely, adversarial processing), so that a voice difference is not easily heard through a human ear.

In a fourth example scenario, the above-mentioned service scenario and the above-mentioned service object can be respectively an abnormality detection scenario and an industrial device. Correspondingly, a service forecasting model can be a model used for abnormality detection. There can be one service label, indicating an industrial device abnormality score. In this case, the service forecasting model is a regression model. Correspondingly, an original sample of the service object can be data collected by a sensor, and a label of the original sample is determined based on alarm data generated when the industrial device is abnormal. The sensor can include a temperature sensor, a humidity sensor, a pressure sensor, etc., and correspondingly, the collected data can include a temperature, a humidity, a pressure, etc. In addition, an adversarial sample can be a sample obtained after the data collected by the sensor is slightly enlarged or reduced, etc.

In a fifth example scenario, the above-mentioned service scenario and the above-mentioned service object can be respectively a risk assessment scenario and a merchant. Correspondingly, a service forecasting model can be a model used to assess a merchant operation risk, that is, determine whether the merchant has an operation risk. There can be two service labels. One service label indicates that there is operation risk, and the other service label indicates that there is no operation risk. In this case, the service forecasting model is a binary-classification model. Correspondingly, a sample of the service object can be transaction information. The transaction information here can include a transaction party, a transaction time, a transaction amount, a transaction network environment, transaction commodity information, etc. In addition, an adversarial sample can be a sample obtained after a transaction amount is slightly enlarged or reduced, a transaction network environment is replaced, etc.

It should be understood that the above-mentioned scenario is merely an example. Actually, the above-mentioned service object can further include another service event such as an access event. In general, the service forecasting model can be a classification model or a regression model, and is used to forecast classification or regression of the service object. In an embodiment, the service forecasting model can be implemented based on a neural network.

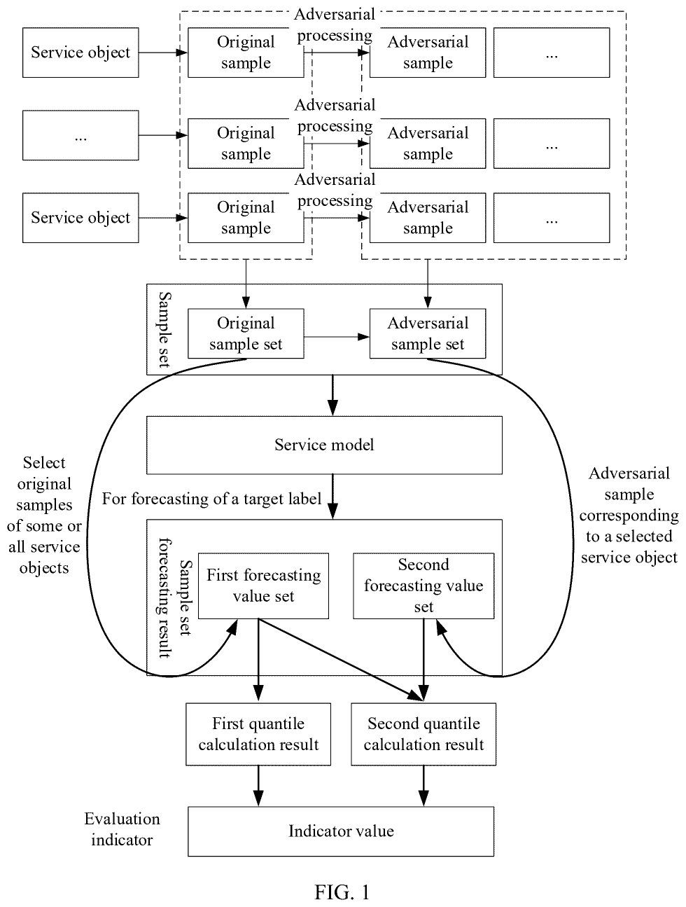

To more clearly describe robustness evaluation of a service forecasting model provided in the embodiments of this application, FIG. 1 is a schematic diagram illustrating a solution to calculate an evaluation indicator in an embodiment. As shown in FIG. 1, a sample set is obtained. The sample set includes an original sample set including respective original samples of a plurality of service objects and an adversarial sample set including respective adversarial samples that are of the plurality of service objects and that are obtained after adversarial processing is performed on all samples in the original sample set. Then, for each sample in the sample set, the sample is input into the service forecasting model to forecast a service label, to obtain a forecasting value corresponding to the sample. Further, all the samples in the sample set are forecasted, and forecasting values corresponding to these samples form a sample set forecasting result. Then, some or all original samples (referred to as first samples for ease of distinguishing) are selected from the original sample set, to form a first sample set. Correspondingly, forecasting values (referred to as first forecasting values for ease of distinguishing) corresponding to all first samples in the first sample set in the sample set forecasting result form a first forecasting value set. Then, quantiles (referred to as first quantiles for ease of description and distinguishing) of all the first forecasting values in the first forecasting value set are calculated, to obtain a quantile calculation result (referred to as a first quantile calculation result for ease of distinguishing). Then, adversarial samples (referred to as second samples for ease of distinguishing) of all the first samples in the first sample set are selected from the adversarial sample set, to form a second sample set. Correspondingly, forecasting values (referred to as second forecasting values for ease of distinguishing) corresponding to all second samples in the second sample set in the sample set forecasting result form a second forecasting value set. Then, quantiles (referred to as second quantiles for ease of description and distinguishing) of all second forecasting values in the second forecasting value set are calculated, to obtain a quantile calculation result (referred to as a second quantile calculation result for ease of distinguishing). Finally, a quantile difference between a first quantile and a second quantile of each service object is determined based on the first quantile calculation result and the second quantile calculation result, and an indicator value of an evaluation indicator of the service forecasting model for the service label is further calculated.

It is worthwhile to note that in actual applications, adversarial processing is performed on each original sample, to obtain one or more adversarial samples. Here, a quantity of adversarial samples of the original sample can be determined with reference to an actual requirement. This is not specifically limited in this embodiment of this specification. Correspondingly, for any adversarial sample, a quantile difference between a second quantile of the adversarial sample and a first quantile of the original sample needs to be calculated.

In an example, the first sample set is the original sample set, and correspondingly, the second sample set is the adversarial sample set.

It is considered that forecasting values for most samples change relatively stably, forecasting values for only a small quantity of samples usually change relatively abnormally, and the small quantity of samples usually easily break through the service forecasting model, and therefore, need to be mainly focused. In another example, the first sample set is some original samples in the original sample set.

In this example, in an implementation, all original samples in the original sample set are ranked starting from 1 based on values of the first forecasting values in the forecasting result, to determine a plurality of first samples. The samples form the first sample set. All adversarial samples corresponding to all first samples are selected from the adversarial sample set, to form the second sample set.

It is considered that the small quantity of samples that easily break through the service forecasting model correspond to either too large or too small forecasting values, in other words, have first rankings or last rankings. For example, the plurality of first samples are a plurality of original samples (for example, the first 10% of original samples) with first rankings, a plurality of original samples (for example, the last 10% of original samples) with last rankings, a plurality of original samples whose ranking numbers are greater than or equal to a first preset ranking number, or a plurality of original samples whose ranking numbers are less than or equal to a second preset ranking number. It is worthwhile to note that the first preset ranking number and the second preset ranking number need to be determined with reference to a quantity of samples in the original sample set. This not specifically limited in this embodiment of this specification. The first preset ranking number and the second preset ranking number can be specifically determined with reference to an actual requirement. For example, the first preset ranking number can be the quantity of samples in the original sample set*90%, and the second preset ranking number can be the quantity of samples in the original sample set*10%.

In another implementation, all adversarial samples in the adversarial sample set are ranked based on values of second forecasting values in the forecasting result, to select some service objects. Respective original samples of the service objects are used as first samples, and respective adversarial samples of the service objects are used as second samples.

It is considered that the small quantity of samples that easily break through the service forecasting model correspond to either too large or too small forecasting values, in other words, have first rankings or last rankings. For example, a selected service object is a service object corresponding to a plurality of adversarial samples (for example, the first 20% of adversarial samples) with first rankings, a plurality of adversarial samples (for example, the last 20% of adversarial samples) with last rankings, a plurality of adversarial samples whose ranking numbers are greater than or equal to a first preset ranking number, or a plurality of adversarial samples whose ranking numbers are less than or equal to a second preset ranking number. It is worthwhile to note that the first preset ranking number and the second preset ranking number need to be determined with reference to a quantity of samples in the adversarial sample set. This not specifically limited in this embodiment of this specification. The first preset ranking number and the second preset ranking number can be specifically determined with reference to an actual requirement. For example, the first preset ranking number can be the quantity of samples in the adversarial sample set*80%, and the second preset ranking number can be the quantity of samples in the adversarial sample set*20%.

In a feasible implementation, the quantile difference between the first quantile and the second quantile of each service object is determined based on the first quantile calculation result and the second quantile calculation result; and the indicator value of the evaluation indicator of the service forecasting model for the service label is determined based on each quantile difference.

A quantile indicates a distribution probability in a specific interval. For example, if there are 1000 numbers (positive numbers), quantiles of 5%, 30%, 50%, 70%, and 99% of these numbers are respectively [3.0, 5.0, 6.0, 9.0, 12.0]. This indicates that 5% of the numbers are distributed between 0 and 3.0, 25% of the numbers are distributed between 3.0 and 5.0, 20% of the numbers are distributed between 5.0 and 6.0, 20% of the numbers are distributed between 6.0 and 9.0, 29% of the numbers are distributed between 9.0 and 12.0, and 1% of the numbers are greater than 12.0.

The following provides descriptions by using an example in which a first sample of each service object corresponds to m second samples. Here, m is greater than or equal to 1.

In an example, a quantile difference Dᵢⱼ between a first sample and the j^{th} second sample that are of the i^{th} service object can be specifically calculated based on Formula (1):

$${D}_{i j} = Q ( {s}_{1 i} / {S}_{1} ) - Q ( {s}_{2 i j} / {S}_{1} ) \qquad ( 1 )$$

Here, s₁ᵢ represents a first forecasting value corresponding to the first sample of the i^{th} service object in the first sample set; s₂ᵢⱼ represents a second forecasting value corresponding to the j^{th} second sample of the i^{th} service object in the second sample set; S₁ represents the first forecasting value set; Q(s₁ᵢ/S₁) represents a quantile of the first forecasting value corresponding to the first sample of the i^{th} service object in the first forecasting value set; and Q(s₂ᵢⱼ/S₁) represents a quantile of the second forecasting value corresponding to the j^{th} second sample of the i^{th} service object in the second sample set in the first forecasting value set.

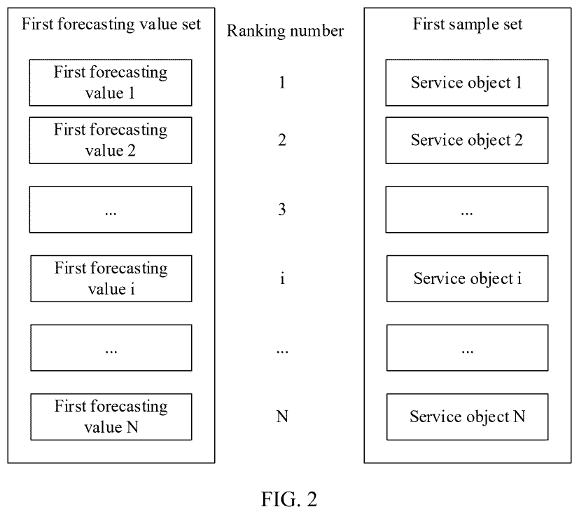

Optionally, for Q(s₁ᵢ/S₁), a quantity Ns₁ᵢ of first forecasting values less than or equal to s₁ᵢ in the first forecasting value set and a quantity NS₁ of first forecasting values in the first forecasting value set can be counted. In this case, Q(s₁ᵢ/S₁)=Ns₁ᵢ/NS₁. Alternatively, all first forecasting values in the first forecasting value set can be ranked in ascending order of the forecasting values, and are numbered starting from 1, to obtain ranking numbers of all the first forecasting values. The ranking number of the first forecasting value is used as a ranking number of a service object corresponding to the first forecasting value, to obtain a ranking number Ss₁ᵢ of the i^{th} service object. In this case, Q(s₁ᵢ/S₁)=Ss₁ᵢ/(NS₁−1). As shown in FIG. 2, if a service object i in the first sample set corresponds to a first forecasting value i in the first forecasting set, and a ranking number of the first forecasting value i is i, a ranking number of the service object i is i.

Optionally, for Q(s₂ᵢⱼ/S₁), a quantity Ns₂ᵢ of first forecasting values less than or equal to s₂ᵢⱼ in the first forecasting value set and a quantity NS₁ of first forecasting values in the first forecasting value set can be counted. In this case, Q(s₂ᵢⱼ/S₁)=Ns₂ᵢ/NS₁. Alternatively, s₂ᵢⱼ and all first forecasting values in the first forecasting value set can be ranked in ascending order of the forecasting values, and are numbered starting from 1, to obtain a ranking number of s₂ᵢⱼ. The ranking number is used as a ranking number Ss₂ᵢ of the i^{th} service object. In this case,

$$Q ( {s}_{2 i j} / {S}_{1} ) = S {s}_{2 i} / ( {NS}_{1} - 1 ) .$$

Further, in a feasible solution, the evaluation indicator is a number deviation, namely, volatility of quantile (VOQ). Specifically, the number deviation VOQ can be calculated based on Formula (2).

$$VOQ = \frac{{\sum }_{i = 1}^{i = n} {\sum }_{j = 1}^{j = m} {D}_{i j}}{n * m} \qquad ( 2 )$$

Here, n represents a quantity of first samples in the first sample set; and m represents a quantity of second samples in the second sample set.

In another feasible solution, the evaluation indicator is a number deviation root-mean-square RMS-VOQ. Specifically, the number deviation root-mean-square RMS-VOQ can be calculated based on Formula (3).

$$RMS - VOQ = \sqrt{\frac{{\sum }_{i = 1}^{i = n} {\sum }_{j = 1}^{j = m} {( {D}_{i j} )}^{2}}{n * m}} \qquad ( 3 )$$

It is worthwhile to note that the evaluation indicator is merely used as an example, and does not constitute any specific limitation. Any evaluation indicator designed based on a quantile can be used.

For a service forecasting model evaluation solution provided in this embodiment of this specification, a forecasting value of a service label for each sample is obtained through forecasting by using the service forecasting model, to calculate a quantile difference between forecasting values of the service label for an original sample and an adversarial sample of a service object, and evaluate robustness of the service forecasting model based on this without depending on a sample label and a threshold. In addition, such an evaluation manner can be applied to service forecasting models in different service scenarios, to compare performance of the service forecasting models in different service scenarios.

Based on the above-mentioned content, the following describes a method for evaluating robustness of a service forecasting model provided in an embodiment of this specification. For details, references can be made to the following descriptions.

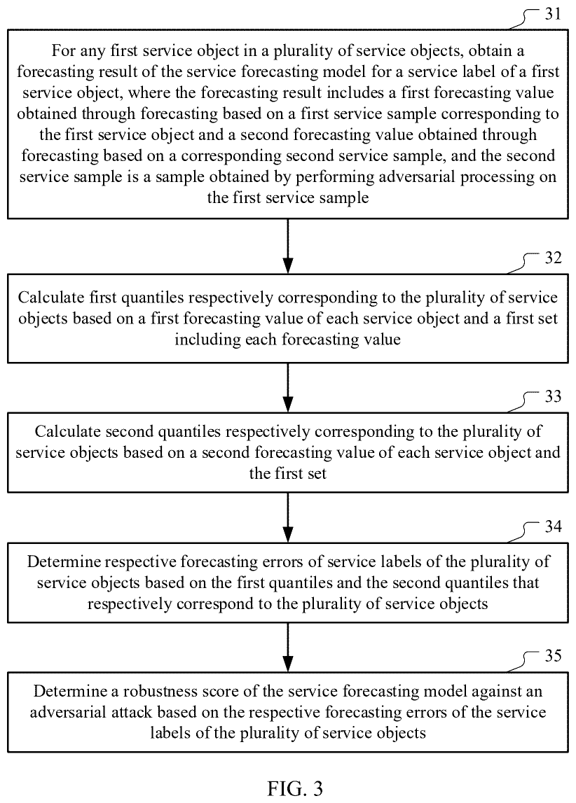

FIG. 3 is a flowchart illustrating a method for evaluating robustness of a service forecasting model in an embodiment. For ease of description, for specific terms in this embodiment of this specification, for example, a service object, a forecasting value, and a quantile, “first”, “second”, etc. are added before the specific terms for distinguishing. Here, “first”, “second”, etc. do not have special meanings, but are only used for ease of distinguishing and description. As shown in FIG. 3, the method includes the following steps.

Step 31: For any first service object in a plurality of service objects, obtain a forecasting result of a service forecasting model for a service label of the first service object, where the forecasting result includes a first forecasting value obtained through forecasting based on a first service sample corresponding to the first service object and a second forecasting value obtained through forecasting based on a corresponding second service sample, and the second service sample is a sample obtained by performing adversarial processing on the first service sample. Step 32: Calculate first quantiles respectively corresponding to the plurality of service objects based on first forecasting values of all the service objects and a first set including all the first forecasting values. Step 33: Calculate second quantiles respectively corresponding to the plurality of service objects based on second forecasting values of all the service objects and the first set. Step 34: Determine respective forecasting errors of the service labels of the plurality of service objects based on the first quantiles and the second quantiles that respectively correspond to the plurality of service objects. Step 35: Determine a robustness score of the service forecasting model against an adversarial attack based on the respective forecasting errors of the service labels of the plurality of service objects.

In a feasible implementation, the plurality of service objects in step 31 are all service objects used to evaluate the service forecasting model. Correspondingly, service samples of the plurality of service objects form the above-mentioned original sample set and the above-mentioned adversarial sample set.

In this implementation, first, in step 31, a single service object in the plurality of service objects is referred to as a first service object below for ease of description and distinguishing. For the first service object, a plurality of service samples of the object are obtained. For any service sample, the sample is input into a service model, and the service model forecasts a service label of the first service object, to obtain a forecasting value for the service sample. Another service sample is processed in a manner the same as the above-mentioned manner, to obtain respective forecasting values of the service label for all service samples, and use the forecasting values as a forecasting result. Specifically, the plurality of service samples of the object include a first service sample (corresponding to an original sample in the original sample set, namely, the above-mentioned first sample). Correspondingly, the forecasting result includes a forecasting value corresponding to the first service sample (corresponding to the above-mentioned first forecasting value). Further, a second service sample (corresponding to a service sample in the adversarial sample set, namely, the above-mentioned second sample) obtained after adversarial processing is performed on the first service sample is further included. Correspondingly, the forecasting result includes a forecasting value corresponding to the second service sample (corresponding to the above-mentioned second forecasting value). It is worthwhile to note that, if adversarial processing is performed on the first service sample for a plurality of times, a plurality of second service samples can be obtained. Correspondingly, the forecasting result includes a second forecasting value for each second service sample. It is worthwhile to note that, in this embodiment of this specification, the robustness of the service forecasting model does not need to be evaluated based on a label of the service sample, and whether the service sample has a label is not specifically limited. In addition, the service sample needs to be determined with reference to a specific service requirement, for example, can be a picture, voice data, or a text. This is not specifically limited in this embodiment of this specification. For detailed content of the service label, references can be made to the above-mentioned descriptions. Details are omitted for simplicity.

A forecasting process of the first service object is described above. Another service object is processed in a manner the same as the above-mentioned manner, to obtain respective forecasting results (including at least the first forecasting value and the second forecasting value) of all the service objects for the service label.

Next, in step 32, for the first service object, a first quantile corresponding to the first service object is determined based on the first forecasting value of the first service object and the first set (the first forecasting value set) including the first forecasting values of the plurality of service objects. Here, the first quantile corresponds to Q(s₁ᵢ/S₁).

In a feasible implementation, the first forecasting values in the first set are ranked in ascending order. The ranking number of the first forecasting value is used as the ranking number of the service object corresponding to the first forecasting value, to obtain ranking numbers (which can be referred to as first ranking numbers for ease of description and distinguishing) respectively corresponding to the plurality of service objects.

Then, for the any first service object, the first quantile corresponding to the first service object can be calculated based on the first ranking number corresponding to the first service object and a total quantity of first forecasting values in the first set. The first quantile corresponds to Q(s₁ᵢ/S₁)=Ss₁ᵢ/(NS₁−1). After the plurality of service objects are processed in the above-mentioned manner, respective first quantiles of the plurality of service objects can be obtained, and correspond to the above-mentioned first quantile calculation result.

In a feasible implementation, for the any first service object, a first quantile of the object is determined based on a quantity of forecasting values less than a first forecasting value of the object in the first set and a total quantity of first forecasting values in the first set, and corresponds to Q(s₁ᵢ/S₁)=Ns₁ᵢ/NS₁. After the plurality of service objects are processed in the above-mentioned manner, respective first quantiles of the plurality of service objects can be obtained, and correspond to the above-mentioned first quantile calculation result.

In step 33, for the first service object, the first quantile corresponding to the first service object is determined based on the second forecasting value of the first service object and the first set. Here, the second quantile corresponds to Q(s₂ᵢⱼ/S₁).

Specifically, the first quantile corresponding to the first service object can be determined in the following three implementations.

Implementation 1: The second forecasting value corresponding to the first service object and all first forecasting values in the first set are ranked in ascending order, to determine a ranking number (referred to as a second ranking number for ease of description and distinguishing) of the second forecasting value corresponding to the first service object, and the second ranking number is used as a second ranking number of the first service object. Then, the first quantile corresponding to the first service object can be calculated based on the second ranking number of the first service object and the total quantity of first forecasting values in the first set, and corresponds to Q(s₂ᵢⱼ/S₁)=Ss₂ᵢ/(NS₁−1).

Implementation 2: The first quantile corresponding to the first service object is determined based on a quantity of forecasting values less than the second forecasting value of the first service object in the first set and the total quantity of first forecasting values in the first set, and correspond to Q(s₂ᵢⱼ/S₁)=Ns₂ᵢ/NS₁.

Implementation 3: An upper limit forecasting value greater than the second forecasting value corresponding to the first service object and a lower limit forecasting value less than the second forecasting value corresponding to the first service object are determined. Then, interpolation is performed on first quantiles respectively corresponding to the upper limit forecasting value and the lower limit forecasting value based on the upper limit forecasting value, the lower limit forecasting value, and the second forecasting value corresponding to the first service object, to determine the second quantile corresponding to the first service object.

Optionally, the upper limit forecasting value is a first forecasting value, in the first set, that has a smallest difference from the second forecasting value corresponding to the first service object and that is greater than the second forecasting value corresponding to the first service object; and the lower limit forecasting value is a first forecasting value, in the first set, that has a smallest difference from the second forecasting value corresponding to the first service object and that is less than the second forecasting value corresponding to the first service object.

Interpolation is an important method for approximating a discrete function. Through interpolation, an approximate value of a function at a point can be estimated based on values of the function at a finite quantity of other points. An interpolation method can be linear interpolation, or can be nonlinear interpolation.

For example, for a linear difference, the second quantile Q corresponding to the first service object can be specifically calculated based on Formula (4).

$$Q = \frac{{d}_{2}}{{d}_{1} + {d}_{2}} * {p}_{1} + \frac{{d}_{1}}{{d}_{1} + {d}_{2}} * {p}_{2} \qquad ( 4 )$$

Here, p₁ represents a first quantile corresponding to the lower limit forecasting value; p₂ represents a first quantile corresponding to the upper limit forecasting value; d₁ represents a difference between the lower limit forecasting value and the second forecasting value corresponding to the first service object; and d₂ represents a difference between the upper limit forecasting value and the second forecasting value corresponding to the first service object.

It is worthwhile to note that the above-mentioned interpolation method is merely used as an example. The interpolation method can be specifically determined with reference to an actual distribution of quantile differences, and is not specifically limited in this embodiment of this specification.

In addition, in some possible implementations, if a target service object exists in the plurality of service objects, that is, a first forecasting value corresponding to the target service object in the first set is the same as the second forecasting value corresponding to the first service object, a first quantile of the target service object is used as the first quantile corresponding to the first service object. If a target service object does not exist in the plurality of service objects, the first quantile corresponding to the first service object is determined in any one of Implementation 1 to Implementation 3.

A manner of determining the first quantile corresponding to the first service object is described in detail above. After the plurality of service objects are processed in the above-mentioned manner, respective second quantiles of the plurality of service objects can be obtained, and correspond to the second quantile calculation result.

Then, in step 34, for the first service object, a forecasting error of the service label of the first service object is determined based on the first quantile and the second quantile that correspond to the first service object.

In a feasible implementation, the forecasting error can be a difference between the first quantile and the second quantile.

It is considered that abnormal data may exist in a quantile error, and consequently, the robustness of the service forecasting model cannot be accurately evaluated. Therefore, in a feasible implementation, the forecasting error of the first service object is a scaled quantile error. Specifically, a quantile error of the service label of the first service object is scaled based on a preset scaling function, quantile differences are normalized, and the scaled quantile difference is used as the forecasting error of the first service object.

In one example, the preset scaling function can be a function for normalization. For example, the scaling function can be a linear function (converting original data into a range of [0, 1] in a linearized manner, implementing uniform scaling, and maintaining a data distribution). For details, references can be made to Formula (5).

$${X}_{inorm} = ( {X}_{i} - {X}_{min} ) / ( {X}_{max} - {X}_{min} ) \qquad ( 5 )$$

Here, Xᵢₙₒᵣₘ represents a value obtained after the it quantile difference in a difference calculation result is scaled; Xᵢ represents the i^{th} quantile difference in the difference calculation result; Xₘₐₓ represents the largest value of all quantile differences in the difference calculation result; and Xₘᵢₙ represents the smallest value of all the quantile differences in the difference calculation result.

For example, the scaling function can be a logarithmic function. Here, a base of the logarithmic function can be 10 or can be e, and can be specifically determined with reference to an actual situation. This is not specifically limited in this embodiment of this specification.

It should be understood that the scaling function is merely used as an example and does not constitute a specific limitation.

It is worthwhile to note that a forecasting error of a single second forecasting value of the first service object is described above. In actual applications, the first service object may have a plurality of second service samples, and therefore, has a plurality of second forecasting values. Correspondingly, there are a plurality of forecasting errors of the service label of the first service object. When robustness evaluation of the service forecasting model is subsequently performed, each forecasting error of the service label of the first service object needs to be considered.

A manner of determining each forecasting error of the service label of the first service object is described in detail above. After the plurality of service objects are processed in the above-mentioned manner, all respective forecasting errors of service labels of the plurality of service objects can be obtained.

It is worthwhile to note that, with reference to step 32 to step 35, respective forecasting errors of the plurality of service objects can be specifically calculated in the following manner.

Example 1: Respective first quantiles of the plurality of service objects are calculated; then respective second quantiles of the plurality of service objects are calculated; and finally, respective forecasting errors of the plurality of service objects are calculated.

Example 2: Respective first quantiles of the plurality of service objects are calculated; for the any first service object, the forecasting error of the first service object is calculated after the first quantile corresponding to the first service object is calculated; and after the plurality of service objects are processed in the above-mentioned manner, respective second quantiles and forecasting errors of the plurality of service objects are obtained.

Example 3: For the any first service object, the first quantile and the second quantile that correspond to the first service object are calculated, and then, the forecasting error of the first service object is calculated. After the plurality of service objects are processed in the above-mentioned manner, respective first quantiles, second quantiles, and forecasting errors of the plurality of service objects are obtained. It is worthwhile to note that, in this example, when the first quantile corresponding to the first service object is calculated, and a target service object exists in the plurality of service objects, that is, a first forecasting value corresponding to the target service object in the first set is the same as the second forecasting value corresponding to the first service object, if the first quantile corresponding to the target service object is calculated, the first quantile of the target service object is directly used as the second quantile of the service object; or if the first quantile of the target service object is not calculated, the second quantile can be calculated in any one of the three implementations of determining the first quantile corresponding to the first service object.

Finally, in step 35, a robustness score of the service forecasting model for the service label can be an average value (corresponding to the number deviation), a standard deviation (corresponding to the number deviation root), or a variance of respective forecasting errors of the plurality of service objects. Specifically, if the forecasting error corresponds to Dᵢⱼ, and m=1, the average value is calculated based on Formula (2), or the standard deviation is calculated based on Formula (3), to obtain a robustness score of the service forecasting model against an adversarial attack for the service label.

A robustness score of the service forecasting model for a single service label is described above. When the service classification model forecasts a plurality of service labels, the robustness score of the service forecasting model against the adversarial attack is further comprehensively evaluated based on robustness scores of the service forecasting model against the adversarial attack for all service labels. For example, weighted averaging is performed on the robustness scores of the service forecasting model against the adversarial attack for all the service labels.

In a feasible implementation, the plurality of service objects in step 31 are some service objects used to evaluate the service forecasting model. For ease of description, all the service objects used to evaluate the service forecasting model are respectively referred to as alternative objects. Here, service samples of a plurality of alternative objects form the original sample set and the adversarial sample set. Before step 31, the following content is further included.

All alternative objects are processed in the manner of processing the first service object, to obtain respective first forecasting values and second forecasting values of all the alternative objects; and the plurality of service objects are selected from the plurality of alternative objects based on the respective first forecasting values or second forecasting values of all the alternative objects.

In an example, the plurality of first service objects are determined from the plurality of alternative objects based on the respective first forecasting values of all the alternative objects in the following manner.

First forecasting values respectively corresponding to all the alternative objects are ranked in ascending order. Then, ranking numbers corresponding to the first forecasting values are used as ranking numbers (referred to as third ranking numbers for ease of description and distinguishing) of second service samples corresponding to all the alternative objects, to obtain respective third ranking numbers of all the alternative objects. Then, an object is selected based on the respective third ranking numbers of all the alternative objects, and each selected alternative object is used as a first service object. For example, the plurality of service objects are a plurality of alternative objects with first rankings. For example, the plurality of service objects are a plurality of alternative objects with last rankings. For example, the plurality of service objects are a plurality of alternative objects whose ranking numbers are greater than or equal to the first preset ranking number. For example, the plurality of service objects are a plurality of alternative objects whose ranking numbers are less than or equal to the second preset ranking number. For detailed content, references can be made to the above-mentioned descriptions. Details are omitted here for simplicity.

The plurality of service objects are determined from the plurality of alternative objects based on the respective second forecasting values of all the alternative objects. For details, references can be made to related content of determining the plurality of service objects from the plurality of alternative objects based on the respective first forecasting values of all the alternative objects.

For detailed content here, references can be made to the above-mentioned descriptions of the first sample set and the second sample set. Details are omitted here for simplicity.

The above-mentioned process is reviewed. In this embodiment of this specification, a forecasting value of the service label for each sample is obtained through forecasting by using the service forecasting model, to calculate a quantile difference between forecasting values of the service label for the original sample and the adversarial sample of the service object, and evaluate the robustness of the service forecasting model based on this without depending on a sample label and a threshold. In addition, such an evaluation manner can be applied to service forecasting models in different service scenarios, to compare performance of the service forecasting models in different service scenarios.

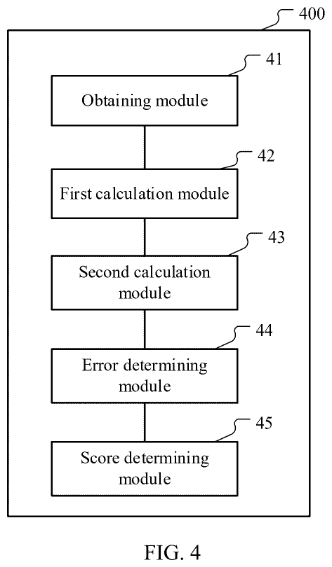

An embodiment of another aspect further provides an apparatus for evaluating robustness of a service forecasting model. FIG. 4 is a schematic structural diagram illustrating an apparatus for evaluating robustness of a service forecasting model in an embodiment. The apparatus can be deployed in any device, platform, or device cluster with a data storage, computing, or processing capability. As shown in FIG. 4, the apparatus 400 includes:
an obtaining module 41, configured to: for any first service object in a plurality of service objects, obtain a forecasting result of a service forecasting model for a service label of the first service object, where the forecasting result includes a first forecasting value obtained through forecasting based on a first service sample corresponding to the first service object and a second forecasting value obtained through forecasting based on a corresponding second service sample, and the second service sample is a sample obtained by performing adversarial processing on the first service sample;
a first calculation module 42, configured to calculate first quantiles respectively corresponding to the plurality of service objects based on first forecasting values of all the service objects and a first set including all the first forecasting values;
a second calculation module 43, configured to calculate second quantiles respectively corresponding to the plurality of first service objects based on second forecasting values of all the first service objects and the first set;
an error determining module 44, configured to determine respective forecasting errors of the service labels of the plurality of first service objects based on the first quantiles and the second quantiles that respectively correspond to the plurality of first service objects; and
a score determining module 45, configured to determine a robustness score of the service forecasting model against an adversarial attack based on the respective forecasting errors of the service labels of the plurality of first service objects.

In each embodiment, the above-mentioned modules are specifically configured to perform steps in the method described with reference to FIG. 3. Details are omitted here for simplicity.

The apparatus obtains a forecasting value of the service label for each sample through forecasting by using the service forecasting model, to calculate a quantile difference between forecasting values of the service label for an original sample and an adversarial sample of a service object, and evaluate the robustness of the service forecasting model based on this without depending on a sample label and a threshold. In addition, such an evaluation manner can be applied to service forecasting models in different service scenarios, to compare performance of the service forecasting models in different service scenarios.

An embodiment of another aspect further provides a computer-readable storage medium. The computer-readable storage medium stores a computer program, and when the computer program is executed on a computer, the computer is enabled to perform the method described with reference to FIG. 3.

According to an embodiment of still another aspect, a computing device is further provided, including a memory and a processor. The memory stores executable code, and when the processor executes the executable code, the method described with reference to FIG. 3 is implemented.

A person skilled in the art should be aware that in the above-mentioned one or more examples, functions described in this application can be implemented by hardware, software, firmware, or any combination thereof. When the functions are implemented by software, the above-mentioned functions can be stored in a computer-readable medium or transmitted as one or more instructions or code in the computer-readable medium.

In the above-mentioned specific implementations, the objectives, technical solutions, and beneficial effects of this application are further described in detail. It should be understood that the above-mentioned descriptions are merely specific implementations of this application, but are not intended to limit the protection scope of this application. Any modification, equivalent replacement, improvement, etc. made based on the technical solutions of this application shall fall within the protection scope of this application.

1. A method for evaluating robustness of a service forecasting model, comprising:
for any first service object in a plurality of service objects, obtaining a forecasting result of the service forecasting model for a service label of a first service object, wherein the forecasting result comprises a first forecasting value obtained through forecasting based on a first service sample corresponding to the first service object and a second forecasting value obtained through forecasting based on a corresponding second service sample, and the second service sample is a sample obtained by performing adversarial processing on the first service sample;
calculating first quantiles respectively corresponding to the plurality of service objects based on a first forecasting value of each service object and a first set comprising each first forecasting value;
calculating second quantiles respectively corresponding to the plurality of service objects based on a second forecasting value of each service object and the first set;
determining respective forecasting errors of service labels of the plurality of service objects based on the first quantiles and the second quantiles that respectively correspond to the plurality of service objects; and
determining a robustness score of the service forecasting model against an adversarial attack based on the respective forecasting errors of the service labels of the plurality of service objects.

2. The method according to claim 1, wherein the calculating first quantiles respectively corresponding to the plurality of service objects comprises:
for the any first service object, determining a first quantile corresponding to the first service object based on a quantity of forecasting values less than the first forecasting value of the first service object in the first set and a total quantity of first forecasting values in the first set; or
ranking the plurality of service objects based on values of the first forecasting values, to obtain first ranking numbers respectively corresponding to the plurality of service objects; and for the any first service object, calculating a first quantile corresponding to the first service object based on a first ranking number corresponding to the first service object and a total quantity of first forecasting values in the first set.

3. The method according to claim 1, wherein the calculating second quantiles respectively corresponding to the plurality of service objects based on a second forecasting value of each service object and the first set comprises:
for the any first service object, when a target service object exists, and a first forecasting value corresponding to the target service object is the same as the second forecasting value corresponding to the first service object, using a first quantile corresponding to the target service object as a second quantile corresponding to the first service object.

4. The method according to claim 1, wherein the calculating second quantiles respectively corresponding to the plurality of service objects based on a second forecasting value of each service object and the first set comprises:
for the any first service object, determining a first quantile corresponding to the first service object based on a quantity of forecasting values less than the second forecasting value of the first service object in the first set and a total quantity of first forecasting values in the first set; or
for the any first service object, ranking the first forecasting value in the first set and the second forecasting value of the first service object based on the values, to determine a second ranking number of the first service object; and calculating a second quantile corresponding to the first service object based on the second ranking number of the first service object and a total quantity of first forecasting values in the first set.

5. The method according to claim 1, wherein the determining respective forecasting errors of service labels of the plurality of service objects based on the first quantiles and the second quantiles that respectively correspond to the plurality of service objects comprises:
determining a quantile error of the service label of the first service object based on a first quantile and a second quantile that correspond to the first service object; and
scaling the quantile error based on a preset scaling function, and using a scaled quantile difference as a forecasting error of the first service object.

6. The method according to claim 1, wherein the forecasting error is a difference between a first quantile and a second quantile of a corresponding service object.

7. The method according to claim 1, wherein the robustness score is determined based on at least an average value, a standard deviation, or a variance of respective forecasting errors of the service labels of the plurality of service objects.

8. The method according to claim 1, wherein the method further comprises:
for each of a plurality of alternative objects, obtaining a forecasting result of the service label of an alternative object by using the service forecasting model, wherein the forecasting result comprises a first forecasting value obtained through forecasting based on a first service sample corresponding to the alternative object and a second forecasting value obtained through forecasting based on a corresponding second service sample, and the second service sample is a sample obtained by performing adversarial processing on the first service sample; and
determining the plurality of service objects from the plurality of alternative objects based on respective first forecasting values or second forecasting values of the plurality of alternative objects.

9. The method according to claim 8, wherein the determining the plurality of service objects from the plurality of alternative objects based on respective first forecasting values of the plurality of alternative objects comprises:
ranking the plurality of alternative objects based on values of the first forecasting values respectively corresponding to the plurality of alternative objects, and determining respective third ranking numbers of the plurality of alternative objects; and
determining the plurality of service objects based on the respective third ranking numbers of the plurality of alternative objects.

10. The method according to claim 9, wherein the plurality of service objects are a plurality of alternative objects with a first ranking, a last ranking, and a ranking number greater than or equal to a first preset ranking number or less than or equal to a second preset ranking number.

11. The method according to claim 1, wherein the service label is a classification, and the first forecasting value and the second forecasting value are probability values; or the service label is a parameter, and the first forecasting value and the second forecasting value are parameter values.

12. The method according to claim 1, wherein the service forecasting model is a facial recognition model, the first service object is a user, the first service sample is an original image of the user, and the second service sample is a perturbed image obtained by adding adversarial noise to the original image.

13. (canceled)

14. A non-transitory storage medium, wherein the computer-readable storage medium stores a computer program, and when the computer program is executed on a computer, the computer is enabled to perform a method for evaluating robustness of a service forecasting model, the method comprises:
for any first service object in a plurality of service objects, obtaining a forecasting result of the service forecasting model for a service label of a first service object, wherein the forecasting result comprises a first forecasting value obtained through forecasting based on a first service sample corresponding to the first service object and a second forecasting value obtained through forecasting based on a corresponding second service sample, and the second service sample is a sample obtained by performing adversarial processing on the first service sample;
calculating first quantiles respectively corresponding to the plurality of service objects based on a first forecasting value of each service object and a first set comprising each first forecasting value;
calculating second quantiles respectively corresponding to the plurality of service objects based on a second forecasting value of each service object and the first set;
determining respective forecasting errors of service labels of the plurality of service objects based on the first quantiles and the second quantiles that respectively correspond to the plurality of service objects; and
determining a robustness score of the service forecasting model against an adversarial attack based on the respective forecasting errors of the service labels of the plurality of service objects.

15. A computing device, comprising a memory and a processor, wherein the memory stores executable code, and when the processor executes the executable code, the processor implements a method for evaluating robustness of a service forecasting model, the method comprises:
for any first service object in a plurality of service objects, obtaining a forecasting result of the service forecasting model for a service label of a first service object, wherein the forecasting result comprises a first forecasting value obtained through forecasting based on a first service sample corresponding to the first service object and a second forecasting value obtained through forecasting based on a corresponding second service sample, and the second service sample is a sample obtained by performing adversarial processing on the first service sample;
calculating first quantiles respectively corresponding to the plurality of service objects based on a first forecasting value of each service object and a first set comprising each first forecasting value;
calculating second quantiles respectively corresponding to the plurality of service objects based on a second forecasting value of each service object and the first set;
determining respective forecasting errors of service labels of the plurality of service objects based on the first quantiles and the second quantiles that respectively correspond to the plurality of service objects; and
determining a robustness score of the service forecasting model against an adversarial attack based on the respective forecasting errors of the service labels of the plurality of service objects.

16. The computing device according to claim 15, wherein the calculating first quantiles respectively corresponding to the plurality of service objects comprises:
for the any first service object, determining a first quantile corresponding to the first service object based on a quantity of forecasting values less than the first forecasting value of the first service object in the first set and a total quantity of first forecasting values in the first set; or
ranking the plurality of service objects based on values of the first forecasting values, to obtain first ranking numbers respectively corresponding to the plurality of service objects; and for the any first service object, calculating a first quantile corresponding to the first service object based on a first ranking number corresponding to the first service object and a total quantity of first forecasting values in the first set.

17. The computing device according to claim 15, wherein the calculating second quantiles respectively corresponding to the plurality of service objects based on a second forecasting value of each service object and the first set comprises:
for the any first service object, when a target service object exists, and a first forecasting value corresponding to the target service object is the same as the second forecasting value corresponding to the first service object, using a first quantile corresponding to the target service object as a second quantile corresponding to the first service object.

18. The computing device according to claim 15, wherein the calculating second quantiles respectively corresponding to the plurality of service objects based on a second forecasting value of each service object and the first set comprises:
for the any first service object, determining a first quantile corresponding to the first service object based on a quantity of forecasting values less than the second forecasting value of the first service object in the first set and a total quantity of first forecasting values in the first set; or
for the any first service object, ranking the first forecasting value in the first set and the second forecasting value of the first service object based on the values, to determine a second ranking number of the first service object; and calculating a second quantile corresponding to the first service object based on the second ranking number of the first service object and a total quantity of first forecasting values in the first set.

19. The computing device according to claim 15, wherein the determining respective forecasting errors of service labels of the plurality of service objects based on the first quantiles and the second quantiles that respectively correspond to the plurality of service objects comprises:
determining a quantile error of the service label of the first service object based on a first quantile and a second quantile that correspond to the first service object; and
scaling the quantile error based on a preset scaling function, and using a scaled quantile difference as a forecasting error of the first service object.

20. The computing device according to claim 15, wherein the forecasting error is a difference between a first quantile and a second quantile of a corresponding service object.

21. The computing device according to claim 15, wherein the robustness score is determined based on at least an average value, a standard deviation, or a variance of respective forecasting errors of the service labels of the plurality of service objects.
